(19) United States
(12) Patent Application Publication
(10) Pub. No.: US 2007/0175930 A1
(43) Pub. Date: Aug. 2, 2007

(54) Container with attachment

(75) Inventors: David B. Heisner, York, PA (US); Mike Mitchell, Manchester, PA (US)

Correspondence Address: VENABLE LLP, P.O. BOX 34385, WASHINGTON, DC, 20043-9998, US

(73) Assignee: GRAHAM PACKAGING COMPANY, L.P., York, PA (US)

(21) Appl. No.: 11/340,578

(22) Filed: Jan. 27, 2006

(51) Int. Cl. B67D 3/00; B67D 5/56

(52) U.S. Cl. 222/538; 222/129; 222/530

(57) ABSTRACT

The present invention is directed to container and method of making the container having a neck and body, wherein the body includes at least one chamber and a recess containing a removable attachment.

### BACKGROUND OF THE INVENTION

1. Field of the Invention

The present invention relates generally to a blow-molded container, and more particularly to a uniformly shaped blow-molded container having a recess for holding an attachment.

2. Description of Related Art

Plastic containers currently available in the art include attachments that are generally adapted for use with the container or enable use of the container and container contents. Such attachments can include, for example, nozzles, hoses, caps and the like. Often these attachments are not removable, requiring that the contents of the container be used all at once. A second problem is that attachments are easily lost because once the container wrap is removed, there no convenient place to keep the attachments. Thus, there is a need in the art for a container having a removable attachment that can be conveniently kept with the container for single or repeat use.

### BRIEF SUMMARY OF THE INVENTION

The present invention is directed to a container having a neck and body. The body includes one chamber and a recess that holds a removable attachment. In an embodiment of the container having multiple chambers, there is a dividing wall extending from the container body to the neck for separating components in the individual chambers. The dividing wall can also extend through the center of the body to a base of the container. The recess can be located on one side of the container body or in the center of the body. The recess can be a through hole and can be open along a continuous arc of 180°.

The container attachment can be secured to the neck of the container by threads or by a snap fit connection. The attachment can be an item such as a funnel, a product applicator, a toy, or promotional item, and can be held in place by a friction fit or compression fit. In order to facilitate handling of the container, the container body can include indentations.

In an embodiment of the container having more than one chamber, each chamber can be for containing a different component, and the container is adapted to equally mix and distribute each component upon dispensing. The container has the ability to prevent a first component in one of the chambers from mixing with a second component is another one of the chambers when the container is closed.

The present invention is also directed to making the container described above by molding a container finish, molding a neck and container body with an area defining a recess, molding an attachment, and fitting the attachment into the recess. For example, the method can include molding a container having at least two separate chambers, where the neck and body are molded to a dividing wall between the chambers. The method can also include placing a heat shrink label around the container and attachment. The area defining the recess can be a pinch area, which can be removed after the container is molded in order to create the recess.

Further objectives and advantages, as well as the structure and function of the preferred embodiments, will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a front view of the container according to one embodiment of the present invention;

FIG. 2 depicts a top view of the container shown in FIG. 1;

FIG. 3A shows a cross section of the container of FIG. 1 along line IIIA-IIIA;

FIG. 3B shows a cross section of the container of FIG. 1 along line IIIB-IIIB;

FIG. 3C shows a cross section of the container of FIG. 1 along line IIIC-IIIC;

FIG. 4 depicts a side view of the container shown in FIG. 1;

FIG. 5 illustrates a cross section of the container taken along line V-V of FIG. 4;

FIG. 6 illustrates the container shown in FIG. 1 with the attachment secured; and

FIG. 7 illustrates a front view of the container according to a second embodiment of the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

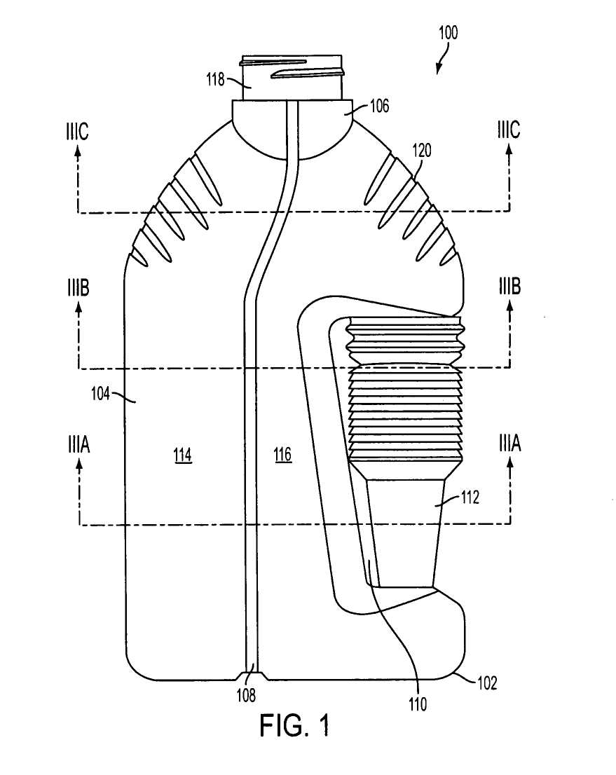

The embodiment of the container 100 as illustrated in FIG. 1 has base 102, body 104, and neck 106. As depicted in the illustrated embodiments, neck 106 includes finish 118. Here the finish has threads, but other finishes known in the art, such as a snap-fit connection, can be used. The present container is adapted for use with suitable closures as known in the art.

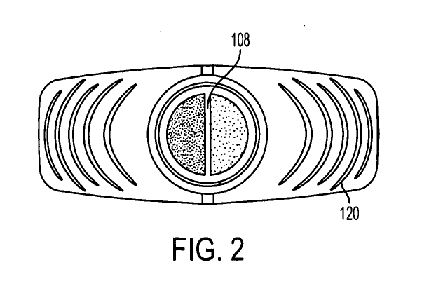

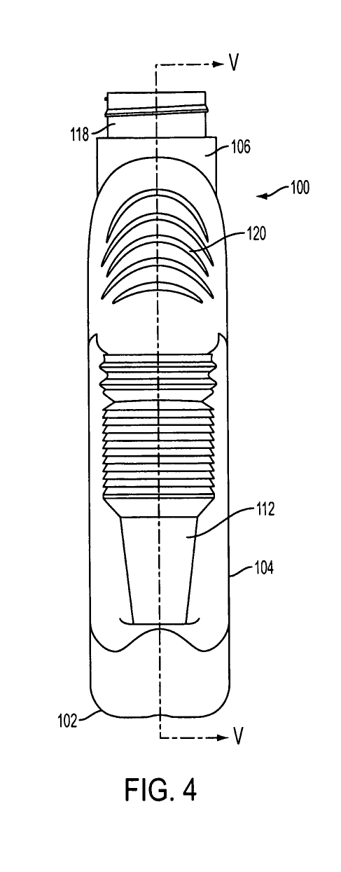

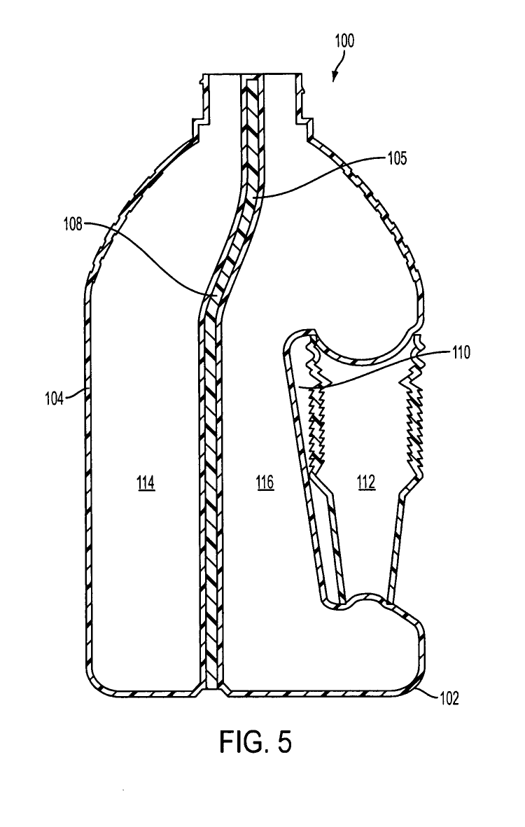

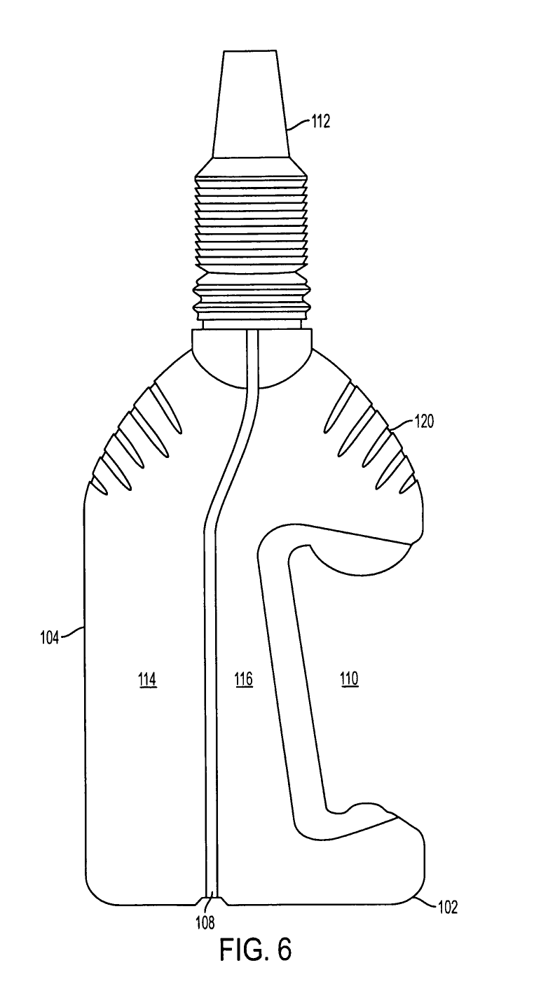

Body 104 includes recess 110 which holds attachment 112. Recess 110 is most visible in FIG. 6. The container has dividing wall 108, which extends from the container body 104 to neck 106 and separates chambers 114 and 116. As shown in FIG. 1, the dividing wall extends through the center of the container body to the base. Also, as shown in FIGS. 2 and 5, the dividing wall extends to the top of the neck. The body can also include indentations 120 for facilitating holding of the container, as shows in FIGS. 1-4.

In embodiments of the invention having more than one chamber, such as the embodiments illustrated in FIGS. 1-7, each chamber may hold a different component. The present container is designed to prevent mixing of components from individual chambers when the bottle is closed or is substantially upright. Once the container contents are poured, individual components are able to mix together. It is the dividing wall 108 that prevents the chamber components from mixing while in the container. Because the dividing wall 108 extends through the neck 106 (see FIG. 2, 5), components are only able to mix once they have exited the container 100.

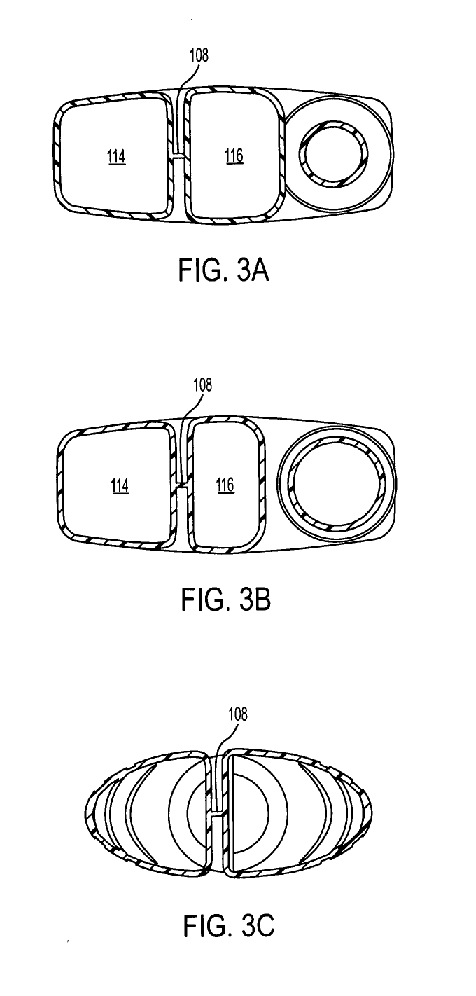

FIGS. 3A-3C depict cross sections of the container taken along lines IIIA-IIIA, IIIB-IIIB, and IIIC-IIIC, respectively. These figures illustrate the embodiment of the present invention having a dual chamber and dividing wall 108. Container 100 can have chambers 114 and 116 that hold equal amounts of their respective components. Alternatively, one chamber can hold a greater amount of its component as compared to the other component.

Recess 110 contains attachment 112. In the illustrated embodiments attachment 112 is a funnel; however, the attachment of the present invention can be any item for use with container 100, or the attachment can be a completely separate item. For example, the attachment can be a product applicator, toy, or promotional item. The attachment can be held in the recess by, for example, a friction fit or compression fit, and can be easily removed and reattached as necessary by a user. Like the neck 106, attachment 112 can also have threads or another structure for securing the attachment 112 to the neck 106.

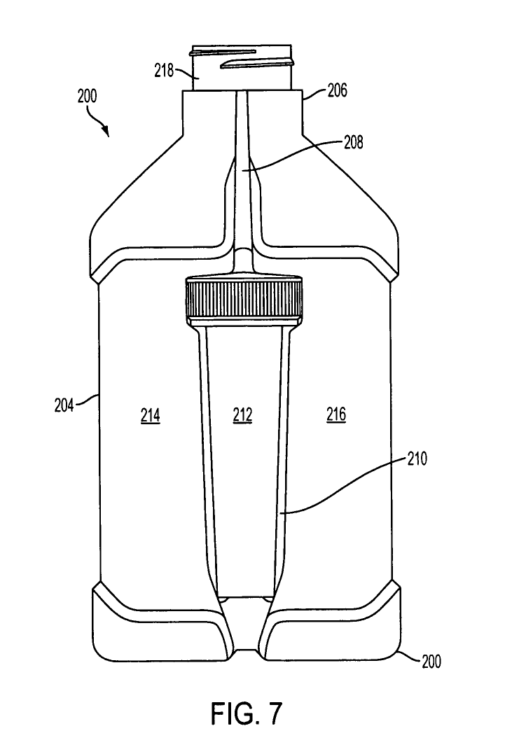

As shown in FIG. 1, recess 110 is to one side of the container body 104. However, alternate placements are within the scope of the invention. For example, as illustrated in FIG. 7, recess 210 is in the center of container body 204. The recess 110, 210 can be described as a through hole; in other words, the recess 110, 210 is open on two opposite sides.

The present invention is also directed to a method of making the container described above. The method can be accomplished, for example, by first molding the container finish, then molding the neck and the body, the body having an area defining a recess. The attachment can be molded at the time the rest of the container is molded, or it can be molded separately. Then the attachment can be fit into the container recess. The area of the body defining the recess can be a pinch area, which is subsequently removed after molding in order to create the recess. The finish can be injection blow molded and the body can be blow molded. The neck and body can also be extrusion blow molded.

The method of manufacturing the present container can also include molding threads on the attachment and securing the attachment to the neck of the container. Additionally, a heat shrink label can be placed around the container and attachment for packaging.

The ability of the present container to hold an attachment has several advantages. One significant advantage is that the chances of losing the attachment are significantly reduced. This is particularly beneficial when the attachment is either required for or greatly enhances the use of the container/product. For instance, if the container holds a chemical product, the attachment can assist with dispensing the chemical(s) so that the user does not come into contact with the chemical(s).

In embodiments of the present invention having multiple chambers, the attachment can allow for mixing and dispensation of chamber components according to a desired ratio. Certain container products require mixing separate components immediately prior to use for proper or optimal results. An attachment such as a funnel is ideal in this situation, as the funnel allows mixing of the chamber components once they have been dispensed from the container.

Another benefit offered by the present invention is convenience of products that are used together. Some possible container and attachment combinations could be, for example, mouthwash with a cup attachment, hair treatments with a product applicator, shampoo with conditioner, cleansing agent with moisturizer, and so on.

Because multi-chambered embodiments of the present invention allow components to be packaged in a single bottle, efficiency is improved. In addition to user convenience in having all necessary components together in one package, the present container cuts down on the amount of resources used by reducing the number of bottles required. The ability to manufacture a single container in the place of two or more individual containers saves both natural resources, money, and manufacturing time. It also allows a user to buy smaller quantities of product that, if bought in larger quantities in separate bottles, might go unused.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A container comprising:
a neck;
a body having at least one chamber; and
a recess containing a removable attachment.

2. The container of claim 1, where in the body has at least two chambers and further comprises a dividing wall separating the chambers, the dividing wall extending from the container body into a neck of the container.

3. The container of claim 1, wherein the recess is located on one side of the container body.

4. The container of claim 1, wherein the recess is located in approximately a center of the container body.

5. The container of claim 1, wherein the attachment is for securing to the neck of the container.

6. The container of claim 4, wherein the attachment is for securing to the neck via threads or a snap-fit connection.

7. The container of claim 4, wherein the attachment is a funnel.

8. The container of claim 1, wherein the attachment is a product applicator, toy, or promotional item.

9. The container of claim 1, wherein the body further comprises indentations to facilitate handling of the container.

10. The container of claim 2, wherein the dividing wall extends through the center of the container body to a base of the container.

11. The container of claim 2, wherein each chamber is for containing a different component and the container is adapted to equally mix and distribute each component upon dispensing.

12. The container of claim 2, wherein the removable attachment is held in place by friction fit or compression fit.

13. The container of claim 1, wherein the recess is a through hole.

14. The container of claim 1, wherein the recess is open along a continuous arc of at least 180 degrees.

15. The container of claim 2, wherein the container prevents a first component in one of the chambers from mixing with a second component in another one of the chambers when the container is closed.

16. A method of manufacturing a container comprising:
molding a container finish;
molding a neck and container body, the body having an area defining a recess;
molding an attachment; and
fitting the attachment into the container recess.

17. The method of claim 16, wherein the container has at least two separate chambers and the neck and body are molded to have a dividing wall between the two chambers.

18. The method of claim 16, further comprising molding threads on the attachment for securing the attachment to the neck of the container.

19. The method of claim 16, further comprising placing a heat shrink label around the container and attachment.

20. The method of claim 16, further comprising blow molding indentations into the body of the container.

21. The method of claim 16, wherein the attachment is a funnel.

22. The method of claim 16, wherein the area defining the recess is a pinch area.

23. The method of claim 22 wherein the pinch area is removed after the container is molded in order to create the recess.
